(19) United States
(12) Patent Application Publication
(10) Pub. No.: US 2026/0281556 A1
(43) Pub. Date: Sep. 17, 2026

(54) SMALL WIRE-BASED IMAGE-CAPTURING SYSTEM

(71) Applicant: SANGWHA Co., Ltd., Seoul (KR)

(72) Inventor: Eun Giu LEE, Gwacheon-si, Gyeonggi-do (KR)

(21) Appl. No.: 19/471,374

(22) PCT Filed: Apr. 11, 2023
(86) PCT No.: PCT/KR2023/004855

§ 371 Date: Dec. 31, 2025

(30) Foreign Application Priority Data
Apr. 3, 2023 (KR) 10-2023-0043608

(51) Int. Cl. H04N 23/695; G06V 10/10; G06V 20/50; H04N 23/56; H04N 23/66; H04N 23/69

(52) U.S. Cl. CPC H04N 23/695; G06V 20/50; H04N 23/66; H04N 23/69; G06V 10/17; H04N 23/56

(57) ABSTRACT

A small wire-based image-capturing system is provided. The small wire-based image-capturing system according to an embodiment of the present invention comprises: a plurality of wires, each having one end installed on an indoor wall surface by means of a fixing anchor; a flying unit connected to the other end of each of the plurality of wires to control the winding or unwinding operation of each of the plurality of wires and thereby move to an arbitrary position in an indoor space; and an image-capturing unit provided below the flying unit to capture images of an object to be image-captured.

### TECHNICAL FIELD

The present disclosure relates to a small wire-based image-capturing system, and more particularly, to a small wire-based image-capturing system having a wire-based flying structure that may be installed indoors to easily implement indoor aerial image-capturing.

### BACKGROUND ART

Recently, with diversification of broadcast content, various image-capturing techniques are emerging. Among them, a three-dimensional aerial movement image-capturing expands a photographing range and allows to capture an image in real time from various angles, and thus, is increasingly used.

As an example, aerial image-capturing uses an unmanned aerial vehicle such as a drone. Here, the aerial image-capturing refers to capturing an image of an object to be image-captured while a camera is flowing at an arbitrary location in three-dimensional space. That is, the aerial image-capturing refers to capturing an image of an object to be image-captured from an altitude higher than that of the object. Although image-capturing using the aerial vehicle is useful outdoors, but is difficult to apply indoors due to several factors such as unstable hovering, wind and noise generated by propeller rotation, and risks of accidents caused by collisions with a subject as well as surrounding objects.

As another example, a flying camera used in soccer fields or large event venues is configured such that a large winch is fixed to ground and a winch wire is installed in a high space to capture images. Since an image-captured area is large, this device needs installation of a tall tower or a fixed structure, and thus, is used specially by professional staff due to safety risks.

Meanwhile, an extended reality (XR) studio uses an image-capturing method that has recently seen considerable development and applications. This image-capturing method includes sending coordinates of a camera to Unreal Engine and projecting or synthesizing images onto a rear light-emitting diode (LED) wall or a green screen to expand a space and create such an illusion that image-capturing is performed in a real environment.

However, since an image-capturing method in the related art employs a special-purpose device installed and operated by professionals and needs expensive equipment, it is difficult to apply this method to personal broadcasting. Accordingly, there is a need for an indoor aerial image-capturing device that may be used for personal broadcasting by non-professionals.

### DISCLOSURE OF INVENTION

### Technical Problem

Therefore, the present disclosure has been made in view of the above problems, and it is an object of the present disclosure to provide a small wire-based image-capturing system having a wire-based flying structure that may be installed indoors to easily implement indoor aerial image-capturing.

### Technical Solution

To accomplish the above object, according to one aspect of the present disclosure, there is provided a small wire-based image-capturing system including: a plurality of wires each having one end installed on a wall surface indoors through fixing anchors; a flying unit connected to another end of each of the plurality of wires and configured to control winding or unwinding operation of each of the plurality of wires to move to an arbitrary position in the indoor space; and an image-capturing unit provided below the flying unit to capture an image of an object to be image-captured.

In an embodiment, the flying unit may include: a housing having openings into which the plurality of wires are drawn, respectively; a plurality of winch parts equipped in the housing and connected to the plurality of wires, respectively, to drive a corresponding wire to be drawn i or out; a tally lamp attached to an outer side of the housing to indicate an operation state; and a circuit board provided at a center between the plurality of winch parts and having a circuit unit mounted thereon.

In an embodiment, the winch parts may include: a main body; a drawn-out part arranged on the main body to be inclined toward the openings; wire guides arranged in the drawn-out part and configured to guide a corresponding wire to be drawn in or out; a drum arranged on a lower surface of the drawn-out part and on an upper side of the main body and having the corresponding wire wound thereon; a brake provided on one side of the drum to restrain driving of the drum; a motor arranged below the drum to provide rotational force to the drum; and a reducer provided on one side of the motor to adjust an output torque by reducing a rotational speed of the motor.

In an embodiment, the flying unit may further include: a safety sensor provided outside the housing to detect an approach by an object; a torque sensor configured to detect a torque of the drum; an encoder configured to control operation of the motor; a storage unit configured to store image-capturing information including an image-capturing location and an image-capturing angle and image information of images captured by the image-capturing unit; and a controller configured to control to avoid collision with a surrounding object according to a result of the detecting by the safety sensor, control the reducer, the brake, and the motor according to a result of the detecting of the torque, and calculate a position of the flying unit within the space according to the encoder.

In an embodiment, the image-capturing unit may include: an extension part arranged below the flying unit; a camera gimbal coupled to the extension part to have an adjustable angle; a camera mounted on the camera gimbal; and an auxiliary lighting lamp configured to operate as auxiliary lighting for the camera.

In an embodiment, the image-capturing unit may include: an extension part arranged below the flying unit; a smartphone gimbal coupled to the extension part to have an adjustable angle; and a smartphone detachably mounted on the smartphone gimbal.

In an embodiment, the smartphone may include: a camera configured to capture an image of the indoor space; a light detection and ranging (LIDAR) configured to detect an object within the indoor space; and a communication unit configured to wirelessly communicate with the flying unit; and a storage unit in which camera information obtained by the capturing is stored.

In an embodiment, a dedicated application (APP) may be installed in the smartphone, and the dedicated application may include: a vision recognition unit configured to recognize an object in the captured image; an image-capturing part configured to capture a part of the captured image; a positioning processing unit configured to adjust a composition of the captured image; an editing unit configured to edit the captured image; and a transmission unit configured to upload the captured image to a server or transmit the captured image to outside.

In an embodiment, the small wire-based image-capturing system may further include a manipulation unit manipulated by a user. Here, the manipulation unit may communicate with the flying unit to manipulate control of operations of the flying unit and the image-capturing unit.

In an embodiment, the flying unit may wiredly communicate with the image-capturing unit to control an image-capturing angle and a zoom operation of the image-capturing unit according to the manipulation by the manipulation unit.

### ADVANTAGEOUS EFFECTS

The small wire-based image-capturing system according to an embodiment of the present disclosure has a wire-based flying structure that may be installed indoors. Thus, since aerial image-capturing may be easily implemented indoors, non-experts may directly use the small wire-based image-capturing system without specialized equipment or help of experts, thereby resulting in expansion of usability.

In addition, the small wire-based image-capturing system according to an embodiment of the present disclosure may have winch parts equipped in a flying unit and fixing anchors configured to fix wires and installed on an indoor wall surface, and may be directly manipulated by a manipulation unit. Accordingly, since installation is easily and operation is simple, all processes such as installation and operation may be performed independently, and thus, convenience of use may be improved.

In addition, the small wire-based image-capturing system according to an embodiment of the present disclosure may move the flying unit three-dimensionally in air by the wires and a winch structure. Thus, a degree of freedom of movement in a space may be improved, and since wind or noise is not generated compared to a drone, product reliability may be enhanced.

In addition, the small wire-based image-capturing system according to an embodiment of the present disclosure may improve safety by preventing a collision during three-dimensional movement in air by attaching a sensor to an outer side of the flying unit and avoiding an obstacle when the obstacle is detected.

In addition, the small wire-based image-capturing system according to an embodiment of the present disclosure may recognize real-time spatial coordinates through a vision camera and an encoder of a motor configured to drive the wires. Thus, since a separate position tracker is not needed, a simple configuration may be implemented at a low cost, thereby improving economic efficiency.

In addition, the small wire-based image-capturing system according to an embodiment of the present disclosure may capture an image by having a smartphone of a user equipped therein. Thus, since a separate camera is not needed, overall cost may be reduced, thereby improving economic efficiency.

### BRIEF DESCRIPTION OF THE DRAWINGS

FIG. 1 is a perspective view illustrating a configuration of a small wire-based image-capturing system according to an embodiment of the present disclosure.

FIG. 2 is a schematic configuration diagram of the small wire-based image-capturing System according to an embodiment of the present disclosure.

FIG. 3 is an enlarged perspective view of a flying unit and an image-capturing unit each included in the small wire-based image-capturing system according to an embodiment of the present disclosure.

FIG. 4 is a perspective view illustrating a state in which a cover of the flying unit of the small wire-based image-capturing system according to an embodiment of the present disclosure is open.

FIG. 5 is an enlarged perspective view of winch parts of the small wire-based image-capturing system according to an embodiment of the present disclosure.

FIG. 6 is a block diagram of the flying unit of the small wire-based image-capturing system according to an embodiment of the present disclosure.

FIG. 7 is a perspective view illustrating another example of the image-capturing unit of the small wire-based image-capturing system according to an embodiment of the present disclosure.

FIG. 8 is a block diagram of a smartphone of the small wire-based image-capturing system according to an embodiment of the present disclosure.

### BEST MODE FOR CARRYING OUT THE INVENTION

Hereinafter, embodiments of the present disclosure will be described in detail with reference to the accompanying drawings so that those skilled in the art may easily implement the present disclosure. The present disclosure may, however, be implemented in many different forms and should not be construed as being limited to the embodiments set forth herein. In the description of the present disclosure, certain detailed explanations are omitted when it is deemed that they may unnecessarily obscure the essence of the present disclosure. Like numbers refer to like elements throughout the description of the figures.

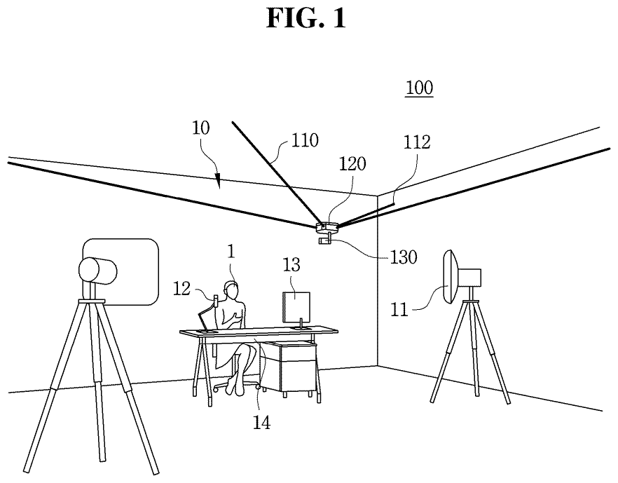

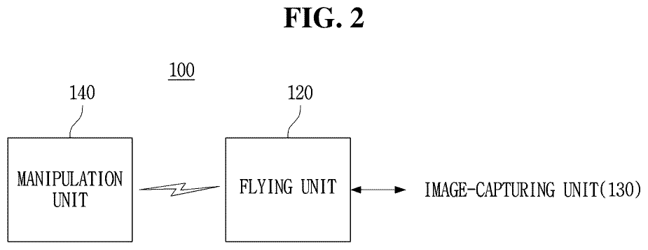

Hereinafter, a small wire-based image-capturing system according to an embodiment of the present disclosure will be described in detail with reference to the drawings. FIG. 1 is a perspective view illustrating a configuration of the small wire-based image-capturing system according to an embodiment of the present disclosure. FIG. 2 is a schematic configuration diagram of the small wire-based image-capturing system according to an embodiment of the present disclosure.

Referring to FIGS. 1 and 2, a small wire-based image-capturing system 100 according to an embodiment of the present disclosure includes wires 110, a flying unit 120, an image-capturing unit 130, and a manipulation unit 140.

The small wire-based image-capturing system 100 is a wire-based three-dimensional (3D) spatial movement image-capturing system configured to capture content such as videos, high-resolution still images, and 3D modeling data with a three-dimensional degree of freedom in air. The small wire-based image-capturing system 100 may capture content without a separate professional operator in small-scale spaces or ordinary residential environments, rather than in professional filming studios. In addition, the small wire-based image-capturing system 100 may perform 3D movement image-capturing with simple installation and setting on fixing anchors, etc. in a small indoor space, and may simulate professional image-capturing. Thus, this may remarkably improve content production quality of small-scale image producers.

As illustrated in FIG. 1, a user 1 may install the small wire-based image-capturing system 100 in an indoor space 10 having a small size, such as a room or an office, and provide a microphone 12 and a monitor 13 for broadcasting to a desk 14 to interoperate with the small wire-based image-capturing system 100. At this time, the user 1 may expand a content production method using a fixed camera to configure a wide variety of dynamic angles when conducting personal broadcasting on a social network service (SNS) or the like using the small wire-based image-capturing system 100. In addition, the user 1 may freely use angles from a jimmy jib or a track camera used in professional broadcasting based on the small wire-based image-capturing system 100 to produce personal content. In addition, the user 1 may recall and use a preferred position and an angle of view, etc., or freely capture images from a shooting position suitable for a situation (e.g., a position looking down from above when capturing an image of food).

Meanwhile, a general large winch system is configured in a such form that winch parts are fixed to a floor, a wire is extended through a pulley at four corner points, and a gimbal camera is positioned at a center point. Accordingly, very specialized and difficult work such as winch fixing, tower installation, and gimbal camera setting is needed for installation. To resolve this, the small wire-based image-capturing system 100 according to an embodiment of the present disclosure is configured such that the winch parts are positioned inside one body rather than outside, only the wires 110 need to be fixed to the outside, and the user 1 may perform all processes alone, and an installation process is also very simple.

In addition, the small wire-based image-capturing system 100 greatly increases a degree of freedom of movement in a space, is not accompanied by wind and noise compared to aerial image-capturing using a drone, and is relatively safe from collisions due to a light weight and a safety sensor.

In addition, extended reality (XR) studio use various expensive trackers to track coordinates of a moving camera in real time. To resolve this, the small wire-based image-capturing system 100 according to an embodiment of the present disclosure recognizes real-time spatial coordinates through a vision camera and an encoder of a wire motor. Accordingly, the small wire-based image-capturing system 100 does not need a separate position tracker.

The wires 110 are provided in a plurality of pieces, and one end of each of the plurality of wires 110 may be installed on a wall surface of the indoor space 10 through fixing anchors 112. Here, the fixing anchors 112 may be installed on a corner wall surface of the indoor space 10. As an example, the fixing anchors 112 may be installed at four positions near ceiling corners of the indoor space 10, respectively. At this time, the fixing anchors 112 may include a ring configured to fix the wires 110, respectively. Another end of each of the plurality of wires 110 may be connected to the flying unit 120.

The flying unit 120 may be connected to each of the plurality of wires 110 to control winding or unwinding operation of each of the plurality of wires 110. As an example, the flying unit 120 may interoperate with each of the plurality of wires 110 to control some wires 110 to be wound while simultaneously controlling other wires 110 to be released. At this time, the flying unit 120 may move to an arbitrary position within the indoor space 10. Here, the arbitrary position means a position corresponding to a 3D coordinate in a vertical direction and a horizontal direction of the indoor space 10. That is, the flying unit 120 may perform aerial flight in the indoor space 10 according to control of the wires 110. Here, the aerial flight means floating within the indoor space 10.

In addition, the flying unit 120 may control operation of the image-capturing unit 130 by wiredly communicating with the image-capturing unit 130. Here, the flying unit 120 may also wirelessly communicate with the image-capturing unit 130. As an example, the flying unit 120 may control an image-capturing angle and a zoom operation of the image-capturing unit 130. Here, the image-capturing angle may include a tilt angle in the vertical direction and a rotation angle in the horizontal direction. At this time, the flying unit 120 may control operation of the image-capturing unit 130 according to manipulation by the manipulation unit 140.

The image-capturing unit 130 is arranged below the flying unit 120 to capture an image of an object to be image-captured. As an example, the image-capturing unit 130 may capture an image of the user 1 or content provided by the user 1 (e.g., plated food, etc.). At this time, the image-capturing unit 130 may capture an image of the object to be image-captured using various methods depending a flying position of the flying unit 120. Here, the flying means that the flying unit 120 flies within the indoor space 10 based on the wires 110 to perform aerial image-capturing, and the flying position means a three-dimensional position within the indoor space 10. Selectively, the image-capturing unit 130 may be provided to be detachably attached to the flying unit 120. Therefore, the image-capturing unit 130 may be selectively coupled to the flying unit 120 depending on a function and a purpose.

As described above, the small wire-based image-capturing system 100 according to an embodiment of the present disclosure has a wire-based flying structure that may be installed indoors. Thus, since aerial image-capturing may be easily implemented indoors, non-experts may directly use the small wire-based image-capturing system 100 without specialized equipment or help of experts, thereby resulting in expansion of usability.

Referring to FIG. 2, the manipulation unit 140 may be manipulated by the user 1. At this time, the manipulation unit 140 may communicate with the flying unit 120 to manipulate control of operations of the flying unit 120 and the image-capturing unit 130. Here, the manipulation unit 140 may communicate with the flying unit 120 via Wi-Fi or Bluetooth. As an example, the manipulation unit 140 may be configured as a joystick type. At this time, the user 1 may manipulate a position of the flying unit 120 and an angle or zoom of the image-capturing unit 130 by pushing or pulling a joystick of the manipulation unit 140 in a particular direction. As another example, the manipulation unit 140 may be configured as a button type. At this time, the user 1 may manipulate a position of the flying unit 120 and an angle or zoom of the image-capturing unit 130 by pressing a direction button of the manipulation unit 140.

As another example, the manipulation unit 140 may be used by installing an application (APP) on a smartphone of the user 1. In addition, the manipulation unit 140 may have a conversation partner function of chat generative pre-trained transformer (GPT), text-to-speech (TTS), or the like.

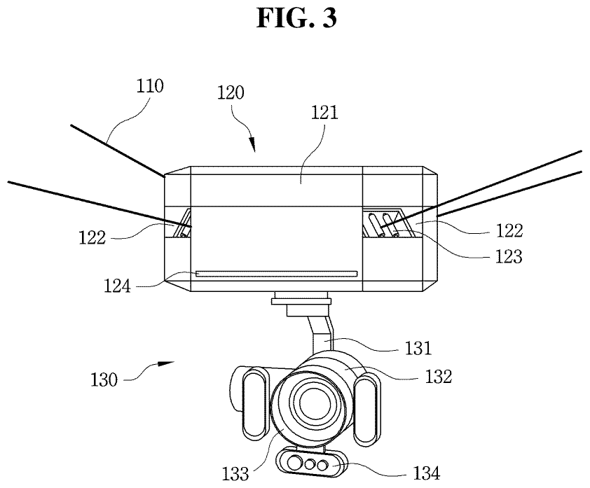

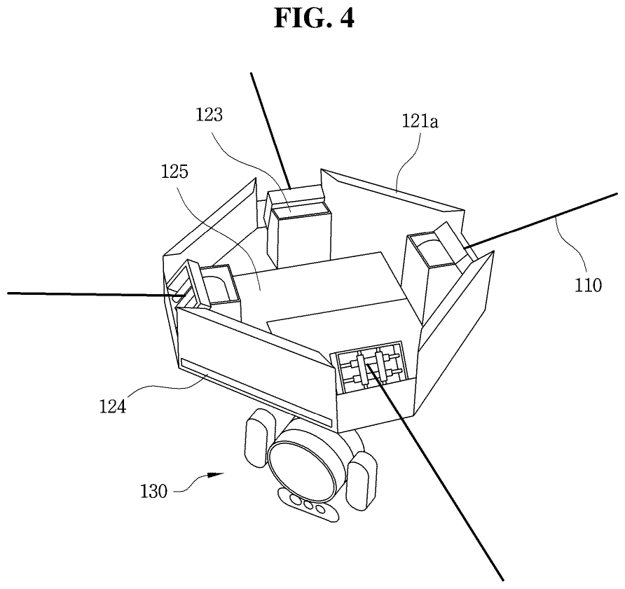

FIG. 3 is an enlarged perspective view of the flying unit and the image-capturing unit each included in the small wire-based image-capturing system according to an embodiment of the present disclosure. FIG. 4 is a perspective view illustrating a state in which a cover of the flying unit of the small wire-based image-capturing system according to an embodiment of the present disclosure is open.

Referring to FIGS. 3 and 4, the flying unit 120 may include a housing 121, winch parts 123, a tally lamp 124, and a circuit board 125.

The housing 121 may include openings 122 into which the plurality of wires 110 are drawn, respectively. At this time, the openings 122 may be arranged to be point-symmetric with respect to a center of the housing 121. As an example, the openings 122 may be provided in front and rear portions (with reference to the drawing) on both sides of the housing 121, respectively. Here, the housing 121 may have an approximately hexahedron shape. The openings 122 may have a certain size to improve a degree of freedom of the wires 110. That is, the wires 110 may move with a high degree of freedom within the openings 122.

The winch parts 123 may be equipped into the housing 121 and connected to the plurality of wires 110, respectively. Here, the winch parts 123 may be provided to be distributed in positions corresponding to the openings 122 of the housing 121. That is, the winch parts 123 may be provided in a same number as the wires 110 and driven to cause a corresponding wire 110 to perform a drawn-in or out operation. That is, the winch parts 123 may be driven to be drawn into the housing 121 or drawn out of the housing 121 to cause each wire 110 to perform a pulling or releasing operation.

The tally lamp 124 may be attached to an outer side of the housing 121 to indicate an operation state. As an example, the tally lamp 124 may be arranged at a lower end of a front surface of the housing 121. Here, the front surface is in a direction toward the user 1, which indicates a direction toward a camera of the image-capturing unit 130. That is, the tally lamp 124 is placed in the direction toward the user 1 so that the user 1 may check an operation state of the small wire-based image-capturing system 100. At this time, the tally lamp 124 may be provided to emit various colors. That is, the tally lamp 124 may emit various colors depending on an operation state of the flying unit 120.

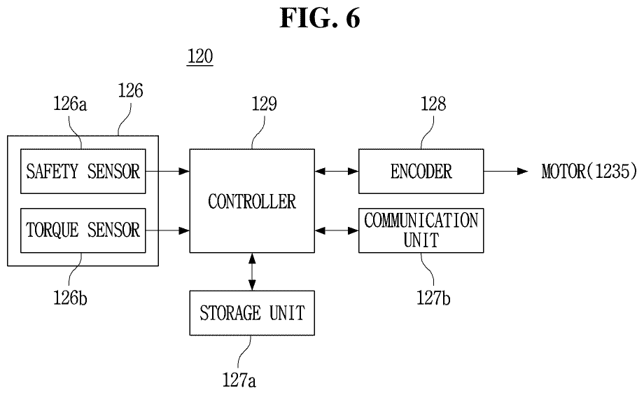

The circuit board 125 may be placed in a lower housing 121a. At this time, the circuit board 125 may be placed between a plurality of the winch parts 123. That is, the circuit board 125 may be provided at a center within the lower housing 121a. A circuit unit may be equipped on the circuit board 125. As an example, the circuit unit may include a storage unit 127a, a communication unit 127b, an encoder 128, and a controller 129 as to be described later with reference to FIG. 6.

As described above, the small wire-based image-capturing system 100 according to an embodiment of the present disclosure may have the winch parts 123 equipped in the flying unit 120 and the fixing anchors 112 configured to fix wires and installed on an indoor wall surface, and may be directly manipulated by the manipulation unit 140. Accordingly, since installation is easily and operation is simple, all processes such as installation and operation may be performed independently, and thus, convenience of use may be improved.

Referring to FIG. 3, the image-capturing unit 130 may include an extension part 131, a camera gimbal 132, a camera 133, and an auxiliary lighting lamp 134.

The extension part 131 may be arranged below the flying unit 120. The extension part 131 is configured to fasten the camera gimbal 132 to the flying unit 120, and may be provided to be detachably attached to the flying unit 120. Selectively, the extension part 131 may be provided integrally with the camera gimbal 132. In addition, the extension part 131 may be installed in a form of an extensible rod like a foldable antenna. Thus, the camera gimbal 132 may be extended downwards by increasing a corresponding length, thereby preventing the wires 110 from descending too low and getting caught on surroundings as possible.

The camera gimbal 132 may be coupled to the extension part 131 to have an adjustable angle. As an example, the camera gimbal 132 may have functions of vertical tilting and horizontal rotation to adjust an image-capturing angle of the camera 133. Selectively, the extension part 131 may have the functions of vertical tilting and horizontal rotation. Additionally, the camera gimbal 132 may operate to maintain balance to prevent shaking of the camera 133 during flight of the flying unit 120.

The camera 133 may be mounted on the camera gimbal 132 to capture an image of an object to be image-captured. As an example, the camera 133 may be a 3D camera including a depth sensor. At this time, the camera 133 may provide 3D information about the object to be image-captured.

The auxiliary lighting lamp 134 may operate for auxiliary adjustment of the camera 133. As an example, the auxiliary lighting lamp 134 may be arranged below the camera 133. However, the auxiliary lighting lamp 134 is not limited thereto, and may be also arranged above the camera 133. In this case, the auxiliary lighting lamp 134 may be arranged not to limit a vertical tilting motion performed by the extension part 131 or the camera gimbal 132.

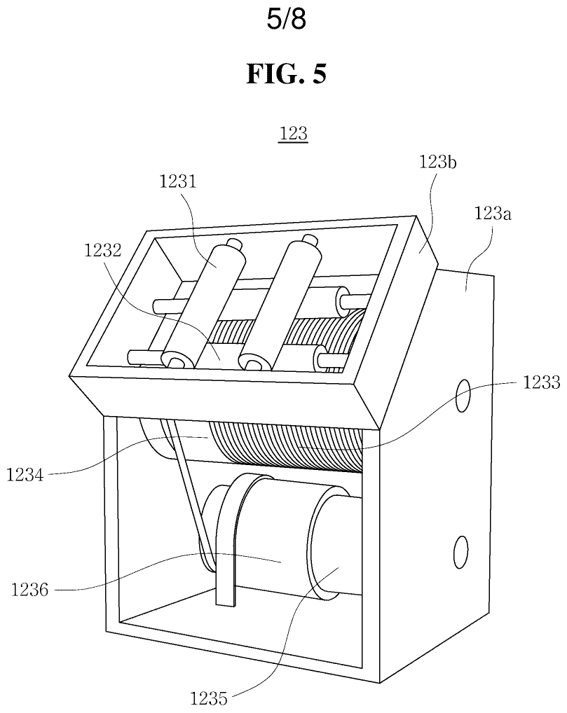

FIG. 5 is an enlarged perspective view of the winch parts of the small wire-based image-capturing system according to an embodiment of the present disclosure.

Referring to FIG. 5, the winch parts 123 may each include a main body 123a, a drawn-out part 123b for a wire, first wire guides 1231, second wire guides 1232, a drum 1233, a brake 1234, a motor 1235, and a reducer 1236. That is, the winch parts 123 may each be a small module in which the above-described components and a driver are integrated with each other. Selectively, a plurality of drivers may be integrated into the circuit board 125.

The main body 123a may have an approximately box shape. The main body 123a is intended to have the above-described components accommodated and integrated therein, and may have some open surfaces.

The drawn-out part 123b may be inclinedly arranged on the main body 123a. That is, the drawn-out part 123b may be arranged to be inclined toward each of the openings 122 while being placed in the lower housing 121a. The drawn-out part 123b functions as a passage through which the wires 110 wound around the winch parts 123 may be drawn in or out, respectively.

The first wire guides 1231 and the second wire guides 1232 may be arranged in the drawn-out part 123b to guide a corresponding wire 110 to be drawn in or out. At this time, the first wire guides 1231 may be provided as a pair in a vertical direction, and the second wire guides 1232 may be provided as a pair in a horizontal direction. Here, the first wire guides 1231 and the second wire guides 1232 may be arranged to be apart from each other by a certain distance to have a form of a “#”. The wires 110 may be drawn in and out through a central passage defined by the first wire guides 1231 and the second wire guides 1232.

The first wire guides 1231 may be arranged vertically in the drawn-out part 123b. Here, the first wire guides 1231 may be arranged on an upper side of the drawn-out part 123b. That is, the first wire guides 1231 may be placed on a further outer side compared to the second wire guides 1232. At this time, the first wire guides 1231 may be coupled to the drawn-out part 123b to move in the horizontal direction. That is, the first wire guides 1231 may move horizontally according to positions of the wires 110 based on rotation of the drum 1233. As an example, the first wire guides 1231 may be slidably coupled into a groove or a slit located at an upper end or a lower end of the drawn-out part 123b. As another example, the first wire guides 1231 may be connected to the drum 1233 by a belt and move within the drawn-out part 123b in left and right directions according to rotation of the drum 1233. This allows the wires 110 to be drawn out stably without overlapping and without any error in lengths.

The second wire guides 1232 may be arranged horizontally within the drawn-out part 123b. Here, the second wire guides 1232 may be arranged on a lower side of the drawn-out part 123b. That is, the second wire guides 1232 may be placed on a further lower side compared to the first wire guides 1231 to be arranged inside. At this time, the second wire guides 1232 may be provided to be fixed to the drawn-out part 123b. That is, the second wire guides 1232 may limit positions of the wires 110 by being fixed not to move even when the positions of the wires 110 are changed due to rotation of the drum 1233. As an example, the second wire guides 1232 may be fixedly connected to left and right sides of the drawn-out part 123b.

As described above, the first wire guides 1231 are arranged to be movable within the drawn-out part 123b, and the second wire guides 1232 are arranged to be fixed to the drawn-out part 123b. Thus, even when a drawn-out or drawn-in position is changed as the wires 110 are wound or unwound on the drum 1233, the wires 110 may be smoothly drawn in or out according to movement of the first wire guides 1231.

Here, it has been described that the first wire guides 1231 are arranged on an outer side of the drawn-out part 123b and the second wire guides 1232 are arranged on an inner side of the drawn-out part 123b. However, the first wire guides 1231 and the second wire guides 1232 are not limited thereto, and may be arranged on opposite positions to those described above.

As an example, the first wire guides 1231 and the second wire guides 1232 may be provided in a form of rollers. That is, the first wire guides 1231 and the second wire guides 1232 may be configured as cylindrical rollers with respect to a rotation axis. At this time, the first wire guides 1231 and the second wire guides 1232 may be rotatably coupled to side surface portions of the drawn-out part 123b. That is, the first wire guides 1231 and the second wire guides 1232 may be rotated by contact force of the wires 110 to cause the wires 110 to be smoothly unwound and wound according to rotation of the drum 1233. Accordingly, when the wires 110 are drawn out or in from the winch parts 123, the first wire guides 1231 and the second wire guides 1232 are rotated. Thus, even when the flying unit 120 moves in position and shakes in air, pulling and releasing operations of the wires 110 may be easily performed.

The drum 1233 is configured to wind the wires 110 and has an approximately cylindrical shape, and may be arranged on an upper side of the main body 123a. At this time, the drum 1233 may be coupled to both sides of the main body 123a to be rotatable around an axis. Additionally, the drum 1233 may be placed on a lower surface of the drawn-out part 123b.

The brake 1234 may be provided on one side of the drum 1233 to restrain driving of the drum 1233. As an example, the brake 1234 may be arranged on a rotation axis of the drum 1233. At this time, the brake 1234 may restrain rotation of the drum 1233 according to control by the controller 129 when the drum 1233 is driven at a certain speed or higher or driven at a certain torque or higher.

The motor 1235 may be arranged below the drum 1233 within the main body 123a. That is, the drum 1233 and the motor 1235 may be arranged in two rows within the main body 123a. The motor 1235 may provide rotational force to the drum 1233. As an example, the motor 1235 may be a step motor. Additionally, the motor 1235 may provide rotational power to the drum 1233 through a pulley belt. At this time, the flying unit 120 may be positioned at an accurate position in a space depending on a degree of winding of the wires 110 due to driving of the motor 1235. Here, power may be supplied to the motor 1235 by a power slip ring structure arranged on a side surface of the main body 123a.

The reducer 1236 may be provided on one side of the motor 1235 to adjust an output torque. That is, the reducer 1236 may adjust the output torque by reducing a rotational speed of the motor 1235. As an example, the reducer 1236 may be placed on a left side of the motor 1235.

As such, the small wire-based image-capturing system 100 according to an embodiment of the present disclosure may move the flying unit 120 three-dimensionally in air by the wires 110 and a winch structure. Thus, a degree of freedom of movement in a space may be improved, and since wind or noise is not generated compared to a drone, product reliability may be enhanced.

FIG. 6 is a block diagram of the flying unit of the small wire-based image-capturing system according to an embodiment of the present disclosure.

Referring to FIG. 6, the flying unit 120 may further include a sensor unit 126, a storage unit 127a, a communication unit 127b, an encoder 128, and a controller 129.

The sensor unit 126 may detect an operation state of the flying unit 120. The sensor unit 126 may include a safety sensor 126a and a torque sensor 126b.

The safety sensor 126a may be provided outside the housing 121 to detect an approach by an object. As an example, the safety sensor 126a may be a distance detection sensor. At this time, the safety sensor 126a may detect an object within a certain distance in which a possibility of collision is high.

The torque sensor 126b may detect a torque of the drum 1233. At this time, the torque sensor 126b is provided on one side of the drum 1233 within the winch parts 123 to detect an operation state of the drum 1233 in real time.

The encoder 128 may control operation of the motor 1235. That is, the encoder 128 may control rotation of the motor 1235. At this time, the encoder 128 may control a degree of winding and unwinding of the wires 110 according to rotation of the motor 1235 with respect to a certain position. Here, the encoder 128 may operate according to control by the controller 129.

The storage unit 127a may store information needed for operation of the flying unit 120. As an example, the storage unit 127a may store image-capturing information including an image-capturing location and an image-capturing angle and image information of images captured by the camera 133. Here, the image-capturing location and the image-capturing angle may be information set by the user 1 to be frequently used.

The communication unit 127b may wirelessly communicate with the manipulation unit 140. As an example, the communication unit 127b may communicate with the manipulation unit 140 via Bluetooth or Wi-Fi. In addition, the communication unit 127b may wiredly or wirelessly communicate with the image-capturing unit 130. At this time, the communication unit 127b may transmit the image information about the images captured by the image-capturing unit 130 to the monitor 13. In addition, the communication unit 127b may communicate to receive a manipulation command from the manipulation unit 140.

The controller 129 may be communicatively connected to the sensor unit 126, the storage unit 127a, the communication unit 127b, and the encoder 128 to control all operations of the flying unit 120. The controller 129 may control to avoid collision with a surrounding object according to a result of detection by the safety sensor 126a. That is, the controller 129 may control the winch parts 123 to cause the flying unit 120 to stop or to turn a moving direction to another direction when a distance to the surrounding object detected by the safety sensor 126a is within a certain range.

As described above, the small wire-based image-capturing system 100 according to an embodiment of the present disclosure may improve safety by preventing a collision during three-dimensional movement in air by attaching a sensor to outside of the flying unit 120 and avoiding an obstacle when the obstacle is detected.

In addition, the controller 129 may control the winch parts 123 according to a result of detecting a torque by the torque sensor 126b. As an example, when a torque of the drum 1233 detected by the torque sensor 126b has a certain magnitude or greater, the controller 129 may control the brake 1234, the motor 1235, and the reducer 1236 to reduce the torque of the drum 1233.

Additionally, the controller 129 may calculate a position of the flying unit 120 within a space using the encoder 128. That is, the controller 129 may calculate a rotational state of the motor 1235 according to a value of the encoder 128 and calculate a degree of winding and unwinding of each wire 110. As a result, the controller 129 may calculate a position of the flying unit 120 based on a position of each wire 110.

As described above, the small wire-based image-capturing system 100 according to an embodiment of the present disclosure may recognize real-time spatial coordinates through a vision camera and the encoder 128 of the motor 1235 configured to drive the wires 110. Thus, since a separate position tracker is not needed, a simple configuration may be implemented at a low cost, thereby improving economic efficiency.

In addition, the controller 129 may control a position (an image-capturing location) and an angle (an image-capturing angle) to be recalled and used from information stored in the storage unit 127a. That is, the controller 129 may control to call and reuse information set by the user 1 through the manipulation unit 140 and stored in the storage unit 127a. At this time, the controller 129 may control the flying unit 120 and the image-capturing unit 130 according to the setting.

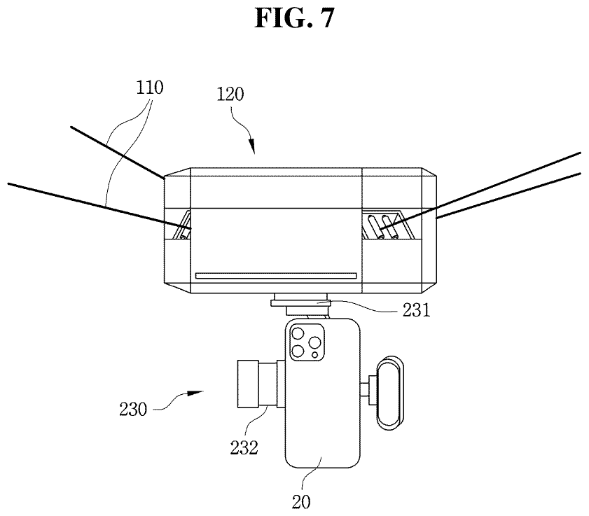

FIG. 7 is a perspective view illustrating another example of the image-capturing unit of the small wire-based image-capturing system according to an embodiment of the present disclosure.

Referring to FIG. 7, the image-capturing unit 230 may be configured using a smartphone 20 without having to separately include the camera 133. That is, the image-capturing unit 230 may be configured to actively utilize resources such as light detection and ranging (LiDAR), camera, and a central processing unit (CPU) of the smartphone owned by the user 1. The image-capturing unit 230 may include an extension part 231, a smartphone gimbal 232, and the smartphone 20.

The extension part 231 may be arranged below the flying unit 120. The extension part 231 may be configured to fasten the smartphone gimbal 232 to the flying unit 120. Selectively, the extension part 231 may be provided integrally with the smartphone gimbal 232.

The smartphone gimbal 232 may be coupled to the extension part 231 to have an adjustable angle. As an example, the smartphone gimbal 232 may have functions of vertical tilting and horizontal rotation to adjust an image-capturing angle of the smartphone 20. Selectively, the extension part 231 may have the functions of vertical tilting and horizontal rotation. Additionally, the smartphone gimbal 232 may operate to maintain balance of the smartphone 20 during flight of the flying unit 120.

The smartphone camera 20 may be detachably mounted on the smartphone gimbal 232 to capture an image of an object to be image-captured. As an example, the smartphone camera 20 may include a depth sensor. At this time, the smartphone camera 20 may provide 3D information about an object to be image-captured.

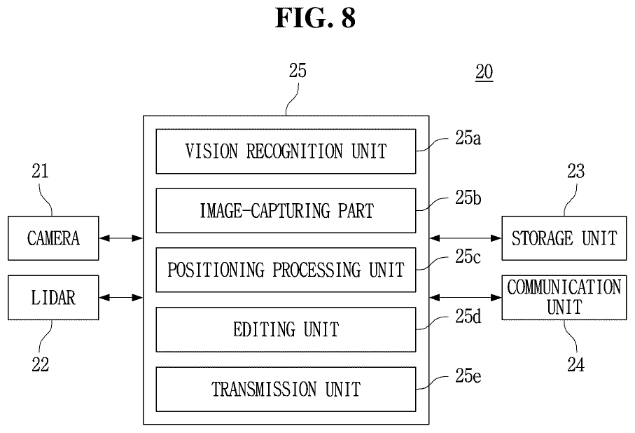

FIG. 8 is a block diagram of the smartphone of the small wire-based image-capturing system according to an embodiment of the present disclosure.

Referring to FIG. 8, the smartphone 20 may include a camera 21, a LIDAR 22, a storage unit 23, a communication unit 24, and a controller 25.

The camera 21 may capture an image of the indoor space 10. That is, the camera 21 may capture an image of a target within the indoor space according to setting by the user 1.

The LiDAR 22 may detect an object in the indoor space 10. At this time, the LiDAR 22 may detect a distance to the detected object. That is, the LiDAR 22 may detect an object within a certain distance in which a possibility of collision is high.

The storage unit 23 may store information needed for operation of the smartphone 20. Additionally, the storage unit 23 may store camera information obtained by performing capturing by the camera 21. Additionally, the storage unit 23 may temporarily store a captured image so that the captured image is processed by the controller 25.

The communication unit 24 may wirelessly communicate with the flying unit 120. As an example, the communication unit 24 may communicate with the flying unit 120 via Bluetooth or Wi-Fi. At this time, the communication unit 24 may transmit image information about an image captured by the camera 21 to the flying unit 120. Selectively, the communication unit 24 may transmit the image information of the captured image to the monitor 13 instead of the flying unit 120.

The controller 25 may be communicatively connected to the camera 21, the LiDAR 22, the storage unit 23, and the communication unit 24 to control all operations of the smartphone 20. At this time, a dedicated application (APP) may be installed in the controller 25. Here, the dedicated application may implement each function of the controller 25. That is, the controller 25 may include a vision recognition unit 25a, an image-capturing part 25b, a positioning processing unit 25c, an editing unit 25d, and a transmission unit 25e each implemented by the dedicated application.

The vision recognition unit 25a may recognize an object in an image captured by the camera 21. At this time, the vision recognition unit 25 a may recognize the object through 3D information in the image. As an example, the vision recognition unit 25a may recognize an object fixedly placed in the indoor space 10 from an object used by the user 1 for a particular purpose to be distinguished from each other.

The image-capturing part 25b may capture a part of the image captured by the camera 21. The image-capturing part 25b may capture the image by the user 1 while checking the image during or after image-capturing through the camera 21.

The positioning processing unit 25c may adjust a composition of the image captured by the camera 21. As an example, the positioning processing unit 25c may control a zoom function of the camera 21.

The editing unit 25d may edit the image captured by the camera 21. The editing unit 25d may edit the image on the smartphone 20 by the user 1 after the image-capturing.

The transmission unit may upload the image captured by the camera 21 to a server (not shown). Selectively, the transmission unit 25e may transmit the image to outside via a server (not shown) when the user 1 performs live broadcasting.

As described above, the small wire-based image-capturing system 100 according to an embodiment of the present disclosure may capture an image by having the smartphone 20 of a user equipped therein. Thus, since a separate camera is not needed, overall cost may be reduced, thereby improving economic efficiency.

Hereinafter, operation of the small wire-based image-capturing system 100 according to an embodiment of the present disclosure will be described.

As illustrated in FIG. 1, the user 1 completes installation of the small wire-based image-capturing system 100 by simply installing the fixing anchors 112 at four points on a wall surface, respectively, and fastening the wires 110 with the fixing anchors 112. At this time, the user 1 places the flying unit 120 at a center of the indoor space 10 and releases the wires 110 as much as possible according to a size of the indoor space 10.

Then, the flying unit 120 may scan an area to be captured in the indoor space 10 through three-dimensional flight. This allows the flying unit 120 to automatically generate an operable range in a three-dimensional space. As such, a basic preparation for image-capturing is completed.

The user 1 may adjust the flying unit 120 for a desired image-capturing location and a desired image-capturing angle through the manipulation unit 140. At this time, the user 1 may adjust the image-capturing location and the image-capturing angle while viewing an image captured by the image-capturing unit 130 through the monitor 13.

Here, according to manipulation of the image-capturing location by the user 1, the flying unit 120 may control the winch parts 123 connected to the respective wires 110 to operate to wind some wires 110 and release other wires 110.

At the same time, the flying unit 120 may control vertical tilting or horizontal rotation of the image-capturing unit 130 according to manipulation by the manipulation unit 140. Accordingly, the user 1 may conduct personal broadcasting by manipulating the flying unit 120 and the image-capturing unit 130 for a desired image-capturing location and a desired image-capturing angle.

Although embodiments of the present disclosure have been described above, the idea of the present disclosure described as above is not limited by the embodiments described herein. It should be apparent to those skilled in the art that various additions, changes, deletions, and modifications of components which are not exemplified herein but are still within the spirit and scope of the present disclosure may be made.

1. A small wire-based image-capturing system comprising:
a plurality of wires each having one end installed on a wall surface indoors through fixing anchors;
a flying unit connected to another end of each of the plurality of wires and configured to control winding or unwinding operation of each of the plurality of wires to move to an arbitrary position in the indoor space; and
an image-capturing unit provided below the flying unit to capture an image of an object to be image-captured.

2. The small wire-based image-capturing system of claim 1, wherein the flying unit comprises:
a housing having openings into which the plurality of wires are drawn, respectively;
a plurality of winch parts equipped in the housing and connected to the plurality of wires, respectively, to drive a corresponding wire to be drawn in or out;
a tally lamp attached to an outer side of the housing to indicate an operation state; and
a circuit board provided at a center between the plurality of winch parts and having a circuit unit mounted thereon.

3. The small wire-based image-capturing system of claim 2, wherein the winch parts comprise:
a main body;
a drawn-out part arranged on the main body to be inclined toward the openings;
wire guides arranged in the drawn-out part and configured to guide a corresponding wire to be drawn in or out;
a drum arranged on a lower surface of the drawn-out part and on an upper side of the main body and having the corresponding wire wound thereon;
a brake provided on one side of the drum to restrain driving of the drum;
a motor arranged below the drum to provide rotational force to the drum; and
a reducer provided on one side of the motor to adjust an output torque by reducing a rotational speed of the motor.

4. The small wire-based image-capturing system of claim 3, wherein the flying unit further comprises:
a safety sensor provided outside the housing to detect an approach by an object;
a torque sensor configured to detect a torque of the drum;
an encoder configured to control operation of the motor;
a storage unit configured to store image-capturing information comprising an image-capturing location and an image-capturing angle and image information of images captured by the image-capturing unit; and
a controller configured to control to avoid collision with a surrounding object according to a result of the detecting by the safety sensor, control the reducer, the brake, and the motor according to a result of the detecting of the torque, and calculate a position of the flying unit within the space according to the encoder.

5. The small wire-based image-capturing system of claim 1, wherein the image-capturing unit comprises:
an extension part arranged below the flying unit;
a camera gimbal coupled to the extension part to have an adjustable angle;
a camera mounted on the camera gimbal; and
an auxiliary lighting lamp configured to operate as auxiliary lighting for the camera.

6. The small wire-based image-capturing system of claim 1, wherein the image-capturing unit comprises:
an extension part arranged below the flying unit;
a smartphone gimbal coupled to the extension part to have an adjustable angle; and
a smartphone detachably mounted on the smartphone gimbal.

7. The small wire-based image-capturing system of claim 6, wherein the smartphone comprises:
a camera configured to capture an image of the indoor space;
a light detection and ranging (LiDAR) configured to detect an object within the indoor space; and
a communication unit configured to wirelessly communicate with the flying unit; and
a storage unit in which camera information obtained by the capturing is stored.

8. The small wire-based image-capturing system of claim 7, wherein a dedicated application (APP) is installed in the smartphone, and
wherein the dedicated application comprises:
a vision recognition unit configured to recognize an object in the captured image;
an image-capturing part configured to capture a part of the captured image;
a positioning processing unit configured to adjust composition of the captured image;
an editing unit configured to edit the captured image; and
a transmission unit configured to upload the captured image to a server or transmit the captured image to outside.

9. The small wire-based image-capturing system of claim 1, further comprising a manipulation unit manipulated by a user,
wherein the manipulation unit communicates with the flying unit to manipulate control of operations of the flying unit and the image-capturing unit.

10. The small wire-based image-capturing system of claim 9, wherein the flying unit wiredly communicates with the image-capturing unit to control an image-capturing angle and a zoom operation of the image-capturing unit according to the manipulation by the manipulation unit.
